(19) United States
(12) Patent Application Publication
(10) Pub. No.: US 2024/0325235 A1
(43) Pub. Date: Oct. 3, 2024

(54) NECK MASSAGER

(71) Applicant: Shenzhen Rainslab Technology Co., Ltd, Shenzhen (CN)

(72) Inventors: Jinhui Ma, Shenzhen (CN); Cihang Li, Shenzhen (CN)

(21) Appl. No.: 18/619,407

(22) Filed: Mar. 28, 2024

(30) Foreign Application Priority Data
Mar. 29, 2023 (CN) 202310333650.7
Jan. 26, 2024 (CN) 202420192734.3

(51) Int. Cl. A61H 7/00

(52) U.S. Cl. CPC A61H 7/004; A61H 7/007; A61H 2201/0188; A61H 2201/0207; A61H 2201/1215; A61H 2201/1611; A61H 2205/04

(57) ABSTRACT

A neck massager is provided. The neck massager includes a main body portion for wrapping around the neck, and a first massage unit and a second massage unit for massaging the neck. The first and second massage units each include a driving gear group driven by meshing transmission, and multiple inclined massage heads driven by the driving gear group. The main body portion is provided with a driving worm, and the driving gear group of the first massage unit and the driving gear group of the second massage unit are respectively set on the left and right sides of the driving worm, and are driven by the driving worm.

### FIELD OF THE INVENTION

The present invention relates to the technical field of medical and health devices, in particular to a neck massager.

### BACKGROUND OF THE INVENTION

In recent years, due to work and unhealthy lifestyle habits, the incidence of neck diseases has shown a trend towards younger generations, and more and more people are troubled by neck diseases. As an effective non-surgical neck health device, neck massagers have become the choice of many neck disease patients.

An existing neck massager has multiple massage units with independent driving units, which occupy a large space, and the output massage head speed and massage angle are not sufficient for the user's neck massage comfort.

### SUMMARY OF THE INVENTION

In view of the above reasons, the object of the present invention is to provide a neck massager with simple drive and transmission, and the massage of the massage head is comfortable for the human neck, which is achieved through the following technical solutions:

A neck massager includes a main body for wrapping around the neck, a first massage unit and a second massage unit both arranged on the main body. Each of the first and second massage units includes a driving gear group driven in meshing transmission, and multiple inclined massage heads driven by the driving gear group. The main body is provided with a driving worm, the driving gear group of the first massage unit and the driving gear group of the second massage unit are respectively set on the left and right sides of the driving worm, and are driven by the driving worm.

In a preferred embodiment, the driving gear group of the first massage unit and the driving gear group of the second massage unit each include a first gear closest to the driving worm, which is sequentially meshed and transmitted until to a final gear of the corresponding driving gear group, a total reduction ratio of the driving gear group of the first massage unit and the total reduction ratio of the driving gear group of the second massage unit are in the range of 150-300, respectively.

In a preferred embodiment, the total reduction ratio of the driving gear group of the first massage unit and the total reduction ratio of the driving gear group of the second massage unit are different.

In a preferred embodiment, the first gears of the driving gear group of the first massage unit and the driving gear group of the second massage unit are both in a first level, and the final gears of the driving gear group of the first massage unit and the driving gear group of the second massage unit are both in a final level, a module, number of teeth, and/or position of at least one pair of the gears in a same level of the first massage unit and the second massage unit are different.

In a preferred embodiment, each of the multiple massage heads of the first massage unit and the second massage unit is connected to the corresponding final gear, with the output speed of multiple massage heads of the first massage unit being the same, and the output speed of multiple massage heads of the second massage unit being the same.

In a preferred embodiment, each of the multiple massage heads of the first massage unit and the second massage unit is directly connected to the corresponding final gear, or connected to the corresponding final gear by inert gear.

In a preferred embodiment, each of the first and second massage units includes three massage heads, with two of the massage heads positioned closer to a center of the main body, and the other massage head positioned relatively away from the center of the main body, when the driving gear group is not working, the three massage heads of each of the first and second massage units are inclined respectively; when the driving gear group is working, the two of the massage heads positioned closer to the center of the main body move towards up and down, while the other massage head positioned relatively away from the center of the main body moves towards an end of the main body.

In a preferred embodiment, each of the massage heads includes a deformable part, a massage base obliquely extending from the deformable part, and a massage cap detachably installed on the massage base, and the deformable part allows the massage base and the massage head to swing in desired directions.

In a preferred embodiment, a lengthwise direction of the massage base together with the massage head is inclined at an angle of 3-30 degrees relative to a centerline of the deformable part.

In a preferred embodiment, a length of the massage head is 10-25 mm, and a diameter of the massage head is 10-18 mm.

In a preferred embodiment, further comprising a fixing bracket and two clamping arms, the fixing bracket supports the main body, and the clamping arms are connected to two ends of the fixing bracket respectively, the fixing bracket extends from the main body, and has an empty space between the main body and the clamping arm, with the length of the empty space being within the range of 45-50 mm, so that the clamping arms are suspended at the ends of the fixing bracket.

In a preferred embodiment, the fixing bracket is curved in a range of 160-180 degrees, and the main body includes an inner shell and an outer shell, the fixing bracket is fixed on the outer surface of the outer shell, and there is a hollow space between the inner shell and the outer shell to accommodate the driving gear groups of the first and second massage units, and the massage heads penetrate out of the inner shell and face the neck.

In a preferred embodiment, the clamping arms are rotatably connected to the two ends of the fixing bracket respectively.

In a preferred embodiment, each of the clamping arms comprises a neck rest and a clamping arm bracket, the neck rest is located on the inner side of the clamping arm bracket, and a sliding mechanism is provided between the neck rest and the clamping arm bracket to allow the neck rest to slide relative to the clamping arm bracket.

In a preferred embodiment, a center of the main body is provided with a heating unit, and an outer side of the clamping arm bracket is provided with an indicator light source for external illumination.

Compared with the prior art, on one hand, the neck massager transmits the drive to the massage units on both sides through the driving worm, and each massage unit is gradually transmitted through the meshing of the driving gear group, so that the drive and transmission is simple. On the other hand, the inclined setting of the massage head is similar to the multi fingers of a simulated human, achieving the best massage comfort.

Furthermore, the neck massager according to a preferred embodiment makes the total reduction ratio of the driving gear group of the first massage unit and the total reduction ratio of the driving gear group of the second massage unit different, allowing users to feel that the massage on both sides of the neck is constantly changing, achieving the most comfortable massage experience.

### BRIEF DESCRIPTION OF THE DRAWINGS

The accompanying drawings are used to provide a further understanding of the present invention, and constitute a part of the description, and are used to explain the present invention together with the embodiments of the present invention, and do not constitute a limitation to the utility model. In the attached drawings:

FIG. 1 is a schematic perspective view of a neck massager according to an embodiment of the present invention.

FIG. 2 is a schematic exploded view of the neck massager according to an embodiment of the present invention.

FIG. 3 is a further exploded view of the neck massager according to an embodiment of the present invention.

FIG. 4 is a still further exploded view of the neck massager according to an embodiment of the present invention.

FIG. 5 shows clamping arms of the neck massager of FIG. 1 rotate outward.

FIG. 6 is an enlarged view of the clamping arm of FIG. 5.

FIG. 7 shows a sliding mechanism between a neck rest and a clamping arm bracket of FIG. 6.

FIG. 8 is a schematic view of a massage main body of the neck massager of FIG. 1.

FIG. 9 is a schematic reverse view of the massage main body of FIG. 8 showing the driving unit.

FIG. 10 is a schematic view of a massage cap of one of the massage heads of FIG. 1 separated from the massage base thereof.

FIG. 11 is an enlarged view of the massage cap of FIG. 10.

FIG. 12 is another schematic view of the massage cap of FIG. 11.

FIG. 13 is a schematic view of a massage cap according to another embodiment of the present invention.

FIG. 14 is another schematic view of the massage cap FIG. 13.

### DETAILED DESCRIPTION OF PREFERRED EMBODIMENTS

The following description will refer to the accompanying drawings to fully describe the contents of the present application. Exemplary embodiments of the application are shown in the drawings. This application may, however, be embodied in many different forms and should not be construed as limited to the exemplary embodiments set forth herein. Rather, these exemplary embodiments are provided so that this application will be thorough and complete, and will fully convey the scope of this application to those skilled in the art. Like reference numerals designate the same or similar components.

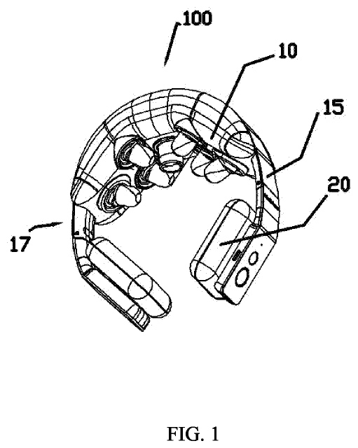

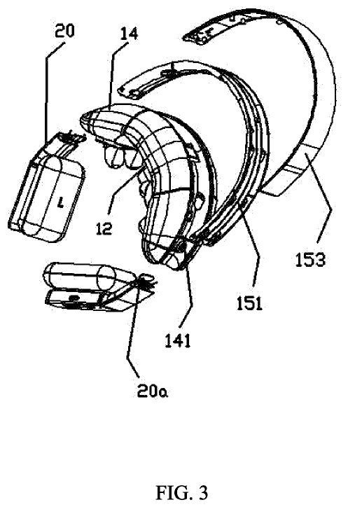

Referring to FIGS. 1-6 together, the present embodiment provides a neck massager 100, which includes a main body 10, a fixing bracket 15, and two clamping arms 20. The fixing bracket 15 supports the main body 10, and the clamping arms 20 are rotatably connected to the fixing bracket 15.

The main body 10 is curved and used to wrap around the neck. The main body 10 includes an inner shell 12, an outer shell 14, and a massage main body 16. The inner shell 12 is located near the neck and is made of soft silicone, while the outer shell 14 is made of hard plastic. The outer shell 12 and the inner shell 14 can be embedded and connected through clamping blocks and slots. There is a hollow space between the inner shell 12 and the outer shell 14 to accommodate the driving unit 160 of the massage main body 16. The outer surface of the outer shell 14 has a concave space 141, and the fixing bracket 15 is arc-shaped. The fixing bracket 15 is accommodated in the concave space 141, and the edges of the outer shell 12 and/or the inner shell 14 can be clamped with the fixing bracket 15.

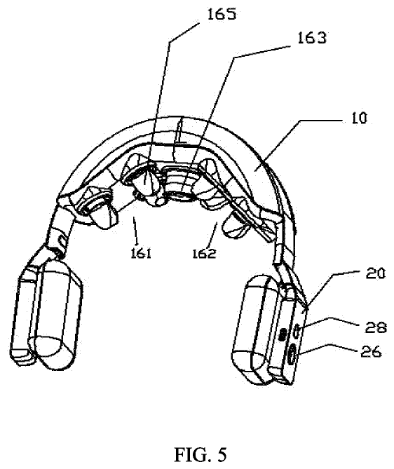

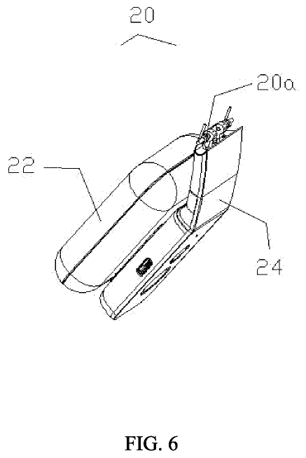

The fixing bracket 15 has an empty space 17 between the main body 10 and each of the clamping arms 20. The dimensions of the empty space 17 along the length direction of the fixing bracket 15 are 45-50 mm, for example, about 48 mm in length. Each of the clamping arms 20 forms a suspension mode under the empty space 17. The fixing bracket 15 forms an arc of 160-180 degrees. In present embodiment, the fixing bracket 15 includes a single main bracket 151 directly connected to the clamping arms 20. A rotation axis 20a (see FIG. 6) can be set at the connection between each of the clamping arms 20 and the main bracket 151 to allow the clamping arm 20 can be rotated, such as outward rotation (see FIG. 5), to expand the wearing comfort requirements for people of different neck sizes, alternatively, in other embodiments, rotate inward to fold the clamping arms 20.

Continue referring to FIG. 6, the clamping arm 20 includes a neck rest 22 and a clamping arm bracket 24, wherein the neck rest 22 is provided on the inner side of the clamping arm bracket 24. The neck rest 22 has a certain thickness and a material layer on the surface that is comfortable for human skin. The neck rest 22 is used for contact with both sides of the cheeks and can fix the entire neck massager 100 on the neck. In present embodiment, the surface of the neck rest 22 is coated with memory cotton material, and the interior of the memory cotton material can be equipped with vibration pads and hot compress pads (not shown). The vibrating pads and hot compress pads can pat and apply heat to the lymph nodes on both sides of the cheeks in working mode, effectively eliminating inflammation and slimming the face while relieving fatigue. The memory cotton material can rely on memory to restore shape.

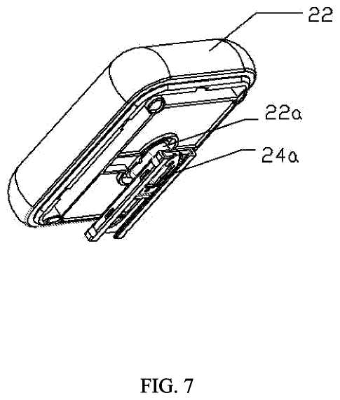

Referring to FIG. 7, a sliding mechanism is provided between the neck rest 22 and the clamping arm 24, allowing the neck rest 22 to slide relative to the clamping arm 24. The sliding mechanism includes a protrusion 22a and a sliding groove 24a. In this embodiment, the protrusion 22a is set on the surface of the neck rest 22 facing the clamping arm 24, and the sliding groove 24a is fixed on the surface of the clamping arm 24 facing the neck rest 22. When the user holds the neck rest 22 and slides it, the protrusion 22a can slide along the sliding groove 24a, thereby moving the neck rest 22 relative to the clamping arm bracket 24, thus adapting to the wearing comfort requirements of people with different neck sizes.

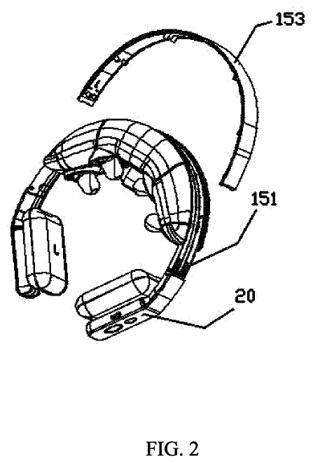

Referring to FIGS. 1-2 again, the fixing bracket 15 further includes a decorative piece 153 covering the surface of the main bracket 151. The decorative piece 153 is accommodated in the recessed space 141 of the housing 14 and extends at both ends. The outer surface of the decorative piece 40 is flush with the outer surface of the outer shell 12 to form a smooth surface of the main body 10. The decorative piece 40 can be decorated with patterns.

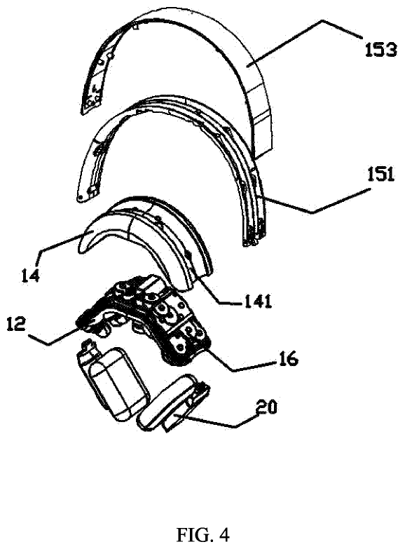

Referring to FIGS. 4-5 and 8-9 together, the massage main body 16 includes a first massage unit 161 and a second massage unit 162, which are located on the left and right sides of the main body 10, respectively. This embodiment is based on the neck acupoints, the first massage unit 161 and the second massage unit 162 respectively include three massage heads 165, which are connected to the driving unit 160 and pass through the inner shell 12 to provide neck massage. The three massage heads 165 are non concentric and can rotate in a centrifugal manner to provide a comfortable massage for the neck.

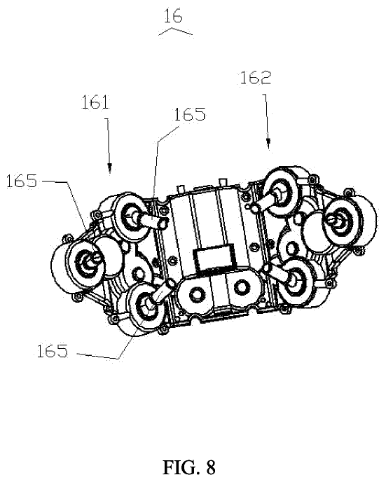

In present embodiment, as shown in FIGS. 1 and 8, when the driving unit 160 is not in working operation, each of the massage heads 165 is inclined in a natural state. The multiple inclined massage heads 165 work like fingers kneading from different angles to achieve the comfort of a human like massage. In particular, two of the massage heads 165 of each of the first massage unit 161 and the second massage unit 162 are positioned closer to the center of the main body 10, and the other massage head 165 is positioned relatively away from the center of the main body 10. When the driving unit 160 is working, the two of the massage heads 165 of each of the first massage unit 161 and the second massage unit 162 closer to the center of the main body move towards up and down of the main body, i.e., move towards the upper and lower positions of the neck, while the other massage head 165 relatively away from the center of the main body and moves towards the end of the main body, i.e., moves towards the side of the neck, thus achieving the best tilt massage comfort.

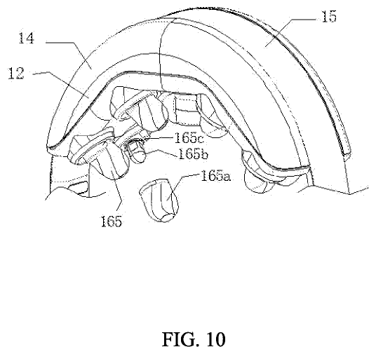

Referring to FIG. 10, each of the massage heads 165 includes a massage cap 165a, a massage base 165b, and a deformable part 165c, the massage base 165b extends obliquely from the deformable part 165c, and the massage cap 165a is detachably installed on the massage base 165b.

The deformable part 165c is made of soft silicone, which can provide the flexibility required for the massage base 165b and the massage cap 165a to rotate in various directions under the rotation drive of the dental box, allowing the massage base 165b and the massage cap 165a to swing in various directions. The massage base 165b is overall in a cylindrical shape, and the massage base 165b is also made of silicone material. The hardness of the massage base 165b is greater than that of the deformable part 165c. The deformable part 165c provides deformable performance, thus allows the massage base 165b and the massage cap 165a to swing in desired directions during the movement process.

The length of each of the massage heads 165 is 10-25 mm, and the maximum diameter of each of the massage heads 165 is 10-18 mm, especially the massage base 165b and the massage cap 165a are inclined with the length direction thereof being at an angle of 3-30 degrees relative to the centerline of the deformable part 165c, so that it work like fingers, and can create a massage effect that simulates the kneading of real human fingers.

Due to the fact that each of the massage heads 165 is the size of a finger and is set at an inclined angle, centrifugal rotation is formed when rotating. Multiple massage heads 165 rotate in a centrifugal manner, creating a massage effect of finger kneading. This highly realistic massage technique deeply penetrates the fascia layer and quickly recovers muscle soreness and fatigue. Simultaneously performing multiple acupoints at the back of the neck can achieve a full neck repair massage effect.

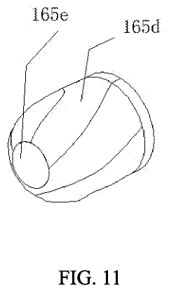

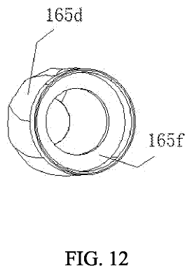

Referring to FIGS. 11-12, in present embodiment, the fingerstyle massage cap 165a includes a first flexible column body 165d and a magnet 165e set on one end of the first flexible column body 165d. The magnet 165e can perform physical therapy on acupoints. The first column body 165d is made of silicone material, and its interior is hollow and placed on the massage base 165b. The inner surface of the first flexible column body 165d has a flexible flange 165f for clamping and placing on the massage base 165b. Due to the hollow interior of the first flexible column body 165d, it is relatively soft. The first flexible column body 165d also has a wavy outer surface to provide a wave like touch when in contact with the skin.

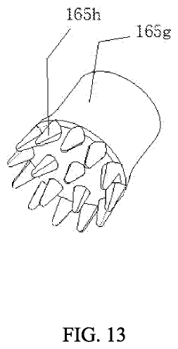

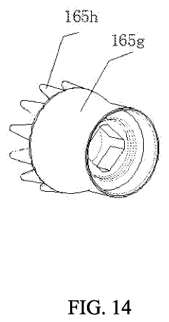

Referring to FIGS. 13-14, in another embodiment, the finger style massage cap 165a includes a second flexible column body 165g and multiple massage claws 165h extending from the second flexible column body 165g. The second flexible column body 165g is hollow and detachable inside and is placed on the massage base 165b. The second flexible column body 165g and multiple massage claws 165h are made of silicone as a whole, making them softer than the aforementioned magnet type. The massage claws 165h can have a gripping effect, thus provides users another massage mode.

The aforementioned magnet 165e type massage head and massage claw 165h type massage head can also be used simultaneously, that is, some finger type massage heads 165 use magnet 165e type, and some finger type massage heads 165 use massage claw 165h type, achieving the effect of different hardness and massage modes when in contact with the skin.

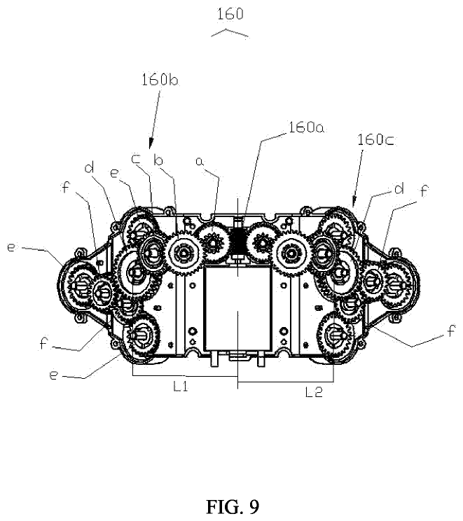

Referring again to FIGS. 8-9, the driving unit 160 of the massage main body 16 is used to drive the first massage unit 161 and the second massage unit 162. As shown in FIG. 9, the driving unit 160 includes a driving worm 160a located in the center, a first driving gear group 160b located on the left, and a second driving gear group 160c located on the right. The first driving gear group 160b is used to drive the three massage heads 165 of the first massage unit 161, and the second driving gear group 160c is used to drive the three massage heads 165 of the second massage unit 162.

The first driving gear group 160b and the second driving gear group 160c are both driven by the driving worm 160a and gradually transmitted, which is beneficial for reducing the volume of the drive unit 160.

Specifically, please refer to FIGS. 8 and 9 together, the first driving gear group 160b and the second driving gear group 160c both include multiple gears. Among the multiple gears of the first driving gear group 160b and the second driving gear group 160c, the gear a closest to the driving worm 160a is the first gear, which is sequentially meshed and transmitted to the final gear e of the multiple gears. The gear a is meshed with the driving worm 160a, the gear b meshes with the gear a, the gear c meshes with the gear b, the gear d meshes with the gear c, and the gear e meshes with gear d.

In this embodiment, there are three gears e, and three massage heads 165 on the same side are respectively connected to one of the gears e. In order to achieve the same output of gear d for the three massage heads 165 at different positions, two gears e can mesh with gear d through gear f. Gear f is an inert gear, which cannot reduce the input speed of gear d, so that the gears e where the three massage heads 165 are located all obtain the same input speed. The modulus and number of teeth of the gear e where the three massage heads 165 are located can be the same, so that gear e also has the same output speed, that is, the three massage heads 165 on the same side have the same input speed and output speed.

Starting from the driving worm 160a, the input speed of each gear is subtracted from its output speed. For example, dividing the input speed of the driving worm 160a to the gear a by the output speed of the gear a to obtain the reduction ratio of gear a. That is, the input speed of the previous gear to the next gear is subtracted from the output speed of the next gear to obtain the reduction ratio of the next gear, until the final drive is transmitted to the gear e where the massage head 165 is located, The multiplication of the various reduction ratios from gear a to gear e results in a total reduction ratio on the same side, so that the total reduction ratio of the entire first driving gear group 160b and the total reduction ratio of the entire second driving gear group 160c are both within the range of 150-300. The total reduction ratio between 150 and 300 is the most comfortable for the human neck, ensuring that the massage heads 165 does not have too much or too little massage speed.

The total reduction ratio of the first driving gear group 160b and the second driving gear group 160c can be different, which allows the user to feel that the massage on both sides of the neck is constantly changing, achieving the most comfortable massage experience. In particular, the aforementioned first gears of the driving gear group 160b of the first massage unit and the driving gear group 160c of the second massage unit are both in a first level, the final gears of the driving gear group 160b of the first massage unit and the driving gear group 160c of the second massage unit are both in a final level, and the different total reduction ratios can be achieved through the asymmetric modulus and number of teeth of a pair of gears in the same levels in the first driving gear group 160b and the second driving gear group 160c, or by changing the modulus and number of teeth of gears in different levels, which can also make the total reduction ratio different left and right. For example, as shown in FIG. 9, the gear d of the first driving gear group 160b and the gear d of the second driving gear group 160c are a pair of gears of the same level, but the modulus (referring to the difference in diameter between the tooth tip circle and the tooth root circle) and/or the number of teeth (the number of teeth on the gear) of the gear d of the first driving gear group 160b and the gear d of the second driving gear group 160c are not the same. The modulus and number of teeth affect the reduction ratio of the gear, especially as the more teeth there are, the slower the output speed, resulting in a difference between the total reduction ratio of the final first driving gear group 160b and the total reduction ratio of the second driving gear group 160c.

In addition, the distance L1 between the gear d of the first driving gear group 160b and the central axis of the drive unit 160 is not equal to the distance L2 between the gear d of the second driving gear group 160c and the central axis of the drive unit 160, that is, the position of a pair of gears in the same level on both sides is asymmetric.

As mentioned above, asymmetry in the modulus, number of teeth, and/or position of the same level gears in the gears of the first driving gear group 160b and the second driving gear group 160c can cause asymmetry between the first driving gear group 160b and the second driving gear group 160c.

Please refer to FIG. 5 again, where a heating unit 163 is located in the middle of the main body 10 to provide comfort during massage. The heating unit 163 can have a heating element and a light-emitting element, and the bottom of the heating unit 163 can be equipped with a spring (not shown) to adapt to the neck. After the heating switch is turned on, the heating element 163 will generate heat, and the luminous element will emit infrared light to indicate entering the massage state. The three massage heads 165 of the first massage unit 161 and the second massage unit 162 are respectively located on both sides of the heating unit 163.

The outer surface of the clamping arm 20 is further equipped with a switch 26 and an indicator light source 28. The indicator light source 28 emits different colors of light in different modes, such as massage mode or meditation music mode, to let others know that the user is using a certain working state of the massager, making the neck massager of this utility model more intelligent.

Concluded from the above, the present invention aims to provide a comfortable neck massager, on one hand, the driving is transmitted to the massage units on the left and right sides through the driving worm, the drive and transmission is simple, and the massage units are gradually transmitted through the meshing of the driving gear group, so that multiple massage heads can achieve a comfortable speed range for the human neck with a total reduction ratio of 150-300. On the other hand, the inclined setting of the massage head is similar to the multi finger massage of a simulated human, achieving the best massage comfort. In the preferred embodiment, the neck massager makes the total reduction ratio of the driving gear group of the first massage unit and the total reduction ratio of the driving gear group of the second massage unit different, allowing users to feel that the massage on both sides of the neck is constantly changing, achieving the most comfortable massage experience.

Hereinbefore, specific embodiments of the present application have been described with reference to the accompanying drawings. However, those skilled in the art can understand that without departing from the scope of the application, various changes and substitutions can be made to the specific embodiments of the application.

What is claimed is:

1. A neck massager, comprising:
a main body for wrapping around the neck;
a first massage unit and a second massage unit both arranged on the main body, each of the first and second massage units comprising a driving gear group driven in meshing transmission, and multiple inclined massage heads driven by the driving gear group,
the main body being provided with a driving worm, the driving gear group of the first massage unit and the driving gear group of the second massage unit being respectively set on the left and right sides of the driving worm, and being driven by the driving worm.

2. The neck massager according to claim 1, wherein the driving gear group of the first massage unit and the driving gear group of the second massage unit each include a first gear closest to the driving worm, which is sequentially meshed and transmitted until to a final gear of the corresponding driving gear group, a total reduction ratio of the driving gear group of the first massage unit and a total reduction ratio of the driving gear group of the second massage unit are in the range of 150-300, respectively.

3. The neck massager according to claim 2, wherein the total reduction ratio of the driving gear group of the first massage unit and the total reduction ratio of the driving gear group of the second massage unit are different.

4. The neck massager according to claim 3, wherein the first gears of the driving gear group of the first massage unit and the driving gear group of the second massage unit are both in a first level, and the final gears of the driving gear group of the first massage unit and the driving gear group of the second massage unit are both in a final level, a module, number of teeth, and/or position of at least one pair of the gears in a same level of the first massage unit and the second massage unit are different.

5. The neck massager according to claim 2, wherein each of the multiple massage heads of the first massage unit and the second massage unit is connected to the corresponding final gear, with the output speed of multiple massage heads of the first massage unit being the same, and the output speed of multiple massage heads of the second massage unit being the same.

6. The neck massager according to claim 5, wherein each of the multiple massage heads of the first massage unit and the second massage unit is directly connected to the corresponding final gear, or connected to the corresponding final gear by inert gear.

7. The neck massager according to claim 6, wherein each of the first and second massage units includes three massage heads, with two of the massage heads positioned closer to a center of the main body, and the other massage head positioned relatively away from the center of the main body, when the driving gear group is not working, the three massage heads of each of the first and second massage units are inclined respectively; when the driving gear group is working, the two of the massage heads positioned closer to the center of the main body move towards up and down, while the other massage head positioned relatively away from the center of the main body moves towards an end of the main body.

8. The neck massager according to claim 7, wherein each of the massage heads includes a deformable part, a massage base obliquely extending from the deformable part, and a massage cap detachably installed on the massage base, and the deformable part allows the massage base and the massage head to swing in desired directions.

9. The neck massager according to claim 8, wherein a lengthwise direction of the massage base together with the massage head is inclined at an angle of 3-30 degrees relative to a centerline of the deformable part.

10. The neck massager according to claim 1, wherein a length of the massage head is 10-25 mm, and a diameter of the massage head is 10-18 mm.

11. The neck massager according to claim 1, further comprising a fixing bracket and two clamping arms, wherein the fixing bracket supports the main body, and the clamping arms are connected to two ends of the fixing bracket respectively, the fixing bracket extends from the main body, and has an empty space between the main body and the clamping arm, with the length of the empty space being within the range of 45-50 mm, so that the clamping arms are suspended at the ends of the fixing bracket.

12. The neck massager according to claim 11, wherein the fixing bracket is curved in a range of 160-180 degrees, and the main body includes an inner shell and an outer shell, the fixing bracket is fixed on the outer surface of the outer shell, and there is a hollow space between the inner shell and the outer shell to accommodate the driving gear groups of the first and second massage units, and the massage heads penetrate out of the inner shell and face the neck.

13. The neck massager according to claim 11, wherein the clamping arms are rotatably connected to the two ends of the fixing bracket respectively.

14. The neck massager according to claim 13, wherein each of the clamping arms comprises a neck rest and a clamping arm bracket, the neck rest is located on the inner side of the clamping arm bracket, and a sliding mechanism is provided between the neck rest and the clamping arm bracket to allow the neck rest to slide relative to the clamping arm bracket.

15. The neck massager according to claim 14, wherein a center of the main body is provided with a heating unit, and an outer side of the clamping arm bracket is provided with an indicator light source for external illumination.
